(19) United States
(12) Patent Application Publication
(10) Pub. No.: US 2024/0192372 A1
(43) Pub. Date: Jun. 13, 2024

(54) LIDAR ENABLED WAYFINDING SYSTEM

(71) Applicant: PHUNWARE, INC., Austin, TX (US)

(72) Inventors: Andrew Soltan, Orange, CA (US); Troy Stump, Irvine, CA (US)

(21) Appl. No.: 18/079,221

(22) Filed: Dec. 12, 2022

(51) Int. Cl. G01S 17/89

(52) U.S. Cl. CPC G01S 17/89

(57) ABSTRACT

A LIDAR enabled wayfinding system includes a LiDAR equipped mapper mobile device adapted to LiDAR-scan within a building to create a building Universal Scene Description (USD), a management server receptive to the building USD and operative to develop a building bundle file including a plurality of waypoints associated with a corresponding plurality of waypoint fingerprints, and a LiDAR equipped user mobile device adapted to LiDAR-scan a user location within the building and to develop a user USD and user location fingerprint that is compared to the plurality of waypoint fingerprints to identify at least one proximate waypoint to the user.

### BACKGROUND

Various technologies have been developed for tracking a user's indoor location and displaying it on a map on a mobile device. These technologies typically include hardware to be installed onsite which the mobile device connects to in order to triangulate the user's location based on how far the user is from each of these hardware devices. The hardware devices may include Bluetooth Low Energy Beacons (BLE), WiFi Access Points, or other Bluetooth devices such as lights or badge readers. Hardware-based wayfinding is preferred indoors because Global Positioning System (GPS) signals are often inaccurate indoors and are unable to provide floor-specific signals.

A disadvantage of using hardware based indoor wayfinding is that these systems are costly and need to be deployed prior to fingerprinting navigation routes for a wayfinding system. Furthermore, they are typically battery-operated and require periodic maintenance.

These and other limitations of the prior art will become apparent to those of skill in the art upon a reading of the following descriptions and a study of the several figures of the drawing.

### SUMMARY

An example LiDAR enabled wayfinding system includes a LiDAR equipped mapper mobile device adapted to LiDAR-scan within a building to create a building Universal Scene Description (USD), a management server receptive to the building USD and operative to develop a building bundle file including a plurality of waypoints associated with a corresponding plurality of waypoint fingerprints, and a LiDAR equipped user mobile device adapted to LiDAR-scan a user location within the building and to develop a user location USD and user location fingerprint that is compared to the plurality of waypoint fingerprints to identify a waypoint proximate to the user location.

An example method for LiDAR enabled wayfinding includes LiDAR-scanning within a building by a user to develop a user location Universal Scene Description (USD), creating a user location fingerprint from the user location USD, comparing the user location fingerprint with a plurality of waypoint fingerprints associated with a plurality of waypoints of the building to predict a waypoint location of the user within the building, and providing directions for the user to navigate from the user location to a desired destination within the building.

An example non-transitory computer readable media includes code segments for LIDAR-scanning a region within a building with a user LiDAR device to develop a user location Universal Scene Description (USD), code segments for creating a location fingerprint from the location USD, code segments for comparing the location fingerprint with a plurality of waypoint fingerprints associated with a plurality of waypoints of the building to predict a waypoint location of the user within the building, and code segments for providing directions to navigate from the user location to a desired destination within the building.

These and other embodiments, features and advantages will become apparent to those of skill in the art upon a reading of the following descriptions and a study of the several figures of the drawing.

### BRIEF DESCRIPTION OF THE DRAWINGS

Several example embodiments will now be described with reference to the drawings, wherein like components are provided with like reference numerals. The example embodiments are intended to illustrate, but not to limit, the invention. The drawings include the following figures:

FIG. 1 is an illustration of a LIDAR enabled wayfinding system;

FIG. 2A is a front view of an example LiDAR equipped mobile device;

FIG. 2B is a rear view of the example LiDAR equipped mobile device of FIG. 2A;

FIG. 3 is a block diagram of an example LiDAR equipped mobile device;

FIG. 4 is a block diagram of an example server device;

FIG. 5 is an illustration of the use of a LiDAR equipped mobile device;

FIGS. 6A-6D are illustrations of several example display types of a LiDAR equipped user mobile device;

FIG. 7 is a flow diagram of an example process implemented by a LiDAR equipped user mobile device of FIG. 1;

FIG. 8 is a flow diagram of an example process implemented by a LIDAR equipped mapper mobile device of FIG. 1;

FIG. 9 is a flow diagram of an example process implemented by a manager station of FIG. 1; and

FIG. 10 is a flow diagram of an example process implemented by a management server of FIG. 1.

### DETAILED DESCRIPTION OF EXAMPLE EMBODIMENTS

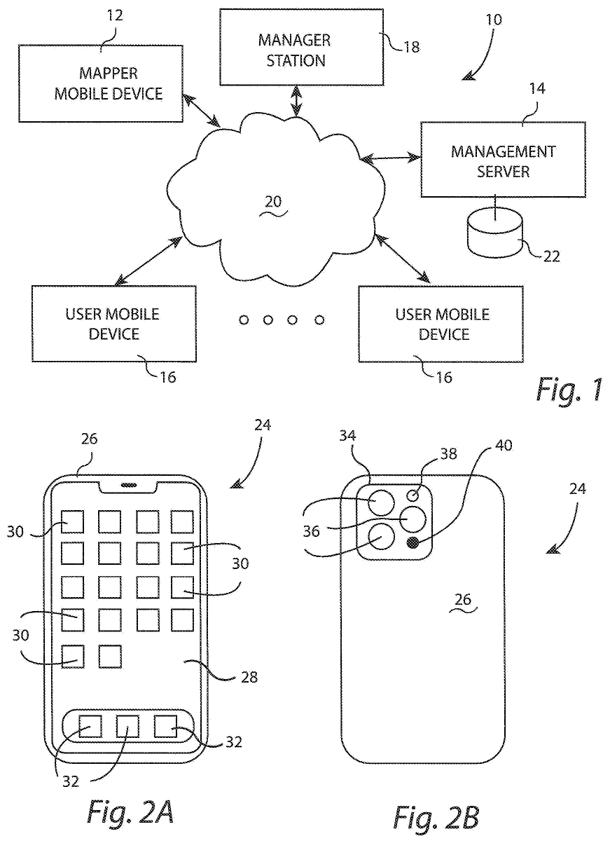

In FIG. 1, an example LiDAR enabled wayfinding system 10 is shown to include a LiDAR equipped mapper mobile device 12, a management server 14, a plurality of LiDAR equipped mobile user devices 16, and a manager station 18. Management server 14, in this example, can communicate with mapper mobile device 12, the plurality of user devices 16, and manager station 18 via a network such as the internet 20 to allow access to a management server database 22.

FIGS. 2A and 2B are front and back views of an example LiDAR equipped mobile device 24 which, with suitable software, can be used for as a hardware/software platform for a LiDAR equipped mapper mobile device 12 and/or LiDAR equipped mobile user device 16. For example, mobile device 24 can be an iPhone™ Pro 13 made by Apple, Inc. of Cupertino, California.

With reference to FIG. 2A, the mobile device 24 has a case 26 and a touchscreen 28 displaying a number of home screen application (“app”) icons 30 and a number of fixed screen app icons 32. Tapping an app icon on the touchscreen 28 launches the associated app. In FIG. 2B the back of LiDAR equipped mobile device 24 includes the case 26 and an area 34 provided with the lenses of three cameras 36, a flash 38, and a LIDAR module 40.

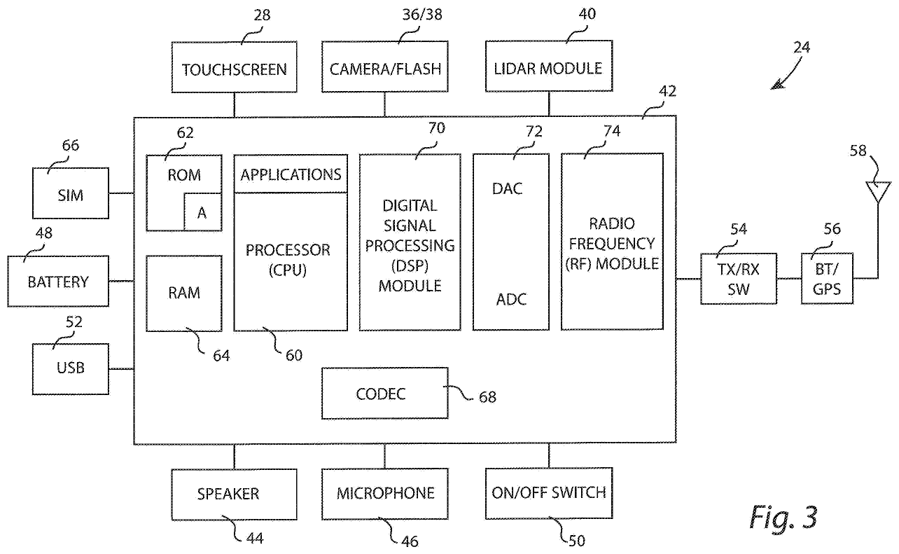

FIG. 3 illustrates, by way of example and not limitation, an electronic block diagram of a LIDAR equipped mobile device 24 including main circuitry 42 and input/output (I/O) components such as touchscreen 28, camera/flash 36/38, LiDAR module 40, speaker 44, and microphone 46. Main circuitry 42 is powered by a battery 48 and is turned on and off with a switch 50. In this example embodiment, the main circuitry 42 is provided with a universal serial bus (USB) 52. A transmit/receive (Tx/Rx) switch 54 and a Bluetooth/GPS (BT/GPS) module 56 couple an antenna 58 to the main circuitry 42.

Main circuitry 42 of LiDAR equipped mobile device 24 includes a processor (CPU) 60, capable of running applications (apps) and read only memory (ROM) 62 coupled to the CPU 60. ROM 62 can be, for example, an electrically erasable, programmable read only memory (EEPROM) or flash memory and can store data, code segments and objects such as an app “A.” Other memory include random access memory (RAM) 64, and a removable subscriber identity module (SIM) 66 which identifies the subscriber and device. The example main circuitry 42 also includes a CODEC 68, a baseband processing and audio/speech processing digital signal processor (DSP) 70, a digital to analog converter (DAC) and analog to digital converter (ADC) 72, and a radio frequency (RF) module 74 for frequency conversion, power amplification, etc.

LiDAR module 40 of a LIDAR equipped mobile device 24 is operative to scan within a field of view (FOV) of one or more of the camera lenses 36 with infrared (I/R) laser pulses and to detect how long it takes for each of the pulses to bounce back. The distance “d” between the LiDAR module 40 and the spot on a surface from which a pulse bounces back is simply d=(c·t)/2, where c is the speed of light and t is the elapsed time between sending and receiving the pulse. In the present example, a LiDAR equipped mobile device 24 is used to scan the interior of a building by sequentially scanning rooms and other areas within the building by moving the mobile device to point at various locations within the rooms, hallways, open areas, etc. of the building.

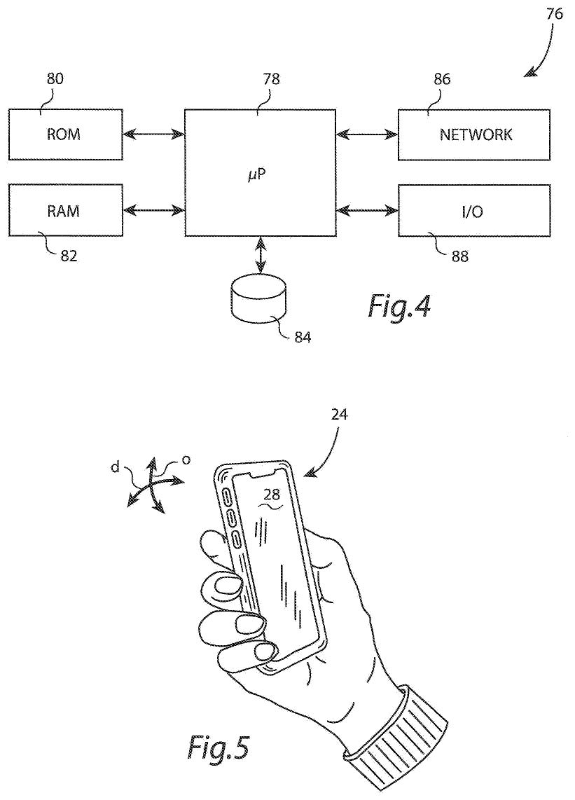

In FIG. 4, an example computer 76 includes a microprocessor (μP) 78, read only memory (ROM) 80, random access memory (RAM) 82, mass storage 84, a network interface 86, and input/output (I/O) 88. Computer 76 is suitable for use as a manager station 18, where the I/O 88 includes a computer monitor, keyboard and mouse, or as management server 14, where the mass storage 88 can be separate from or include the management server database 22. The computer 76 can also be used to combine the functions of the management server 14 and the management station 18 as a unitary computer/server.

FIG. 5 illustrates a use of the LiDAR equipped mobile device 24 as an environmental scanner, e.g. as a mapper mobile device 12 or a user mobile device 16 to develop a 3D model of one or more interior regions of a building, where the 3D model can be stored in a Universal Scene Description (USD) format. In this example, the LiDAR equipped mobile device 24 is held by hand with the touchscreen 28 facing the user to facilitate LiDAR-scanning of the environment in a number of directions “d” and orientations “o”. The app (e.g. app “A” of FIG. 3) controlling the LiDAR-scanning process can, in this example, ask the user to hold up the LiDAR equipped mobile device 24 and slowly scan the environment, e.g. a room, by walking around and changing the direction and orientation of the device until the entire room has been scanned. Preferably, the app A would provide visual indicators that walls, windows and other objects are being successfully scanned. If the user is moving too quickly, the app A would recommend that they slow down. Once a room has been completed, the process can be repeated for other rooms, hallways, open spaces, etc. Other data such as compass, altimeter, BLE Bluetooth, WiFi and/or GPS data (if available) can be included for additional detail.

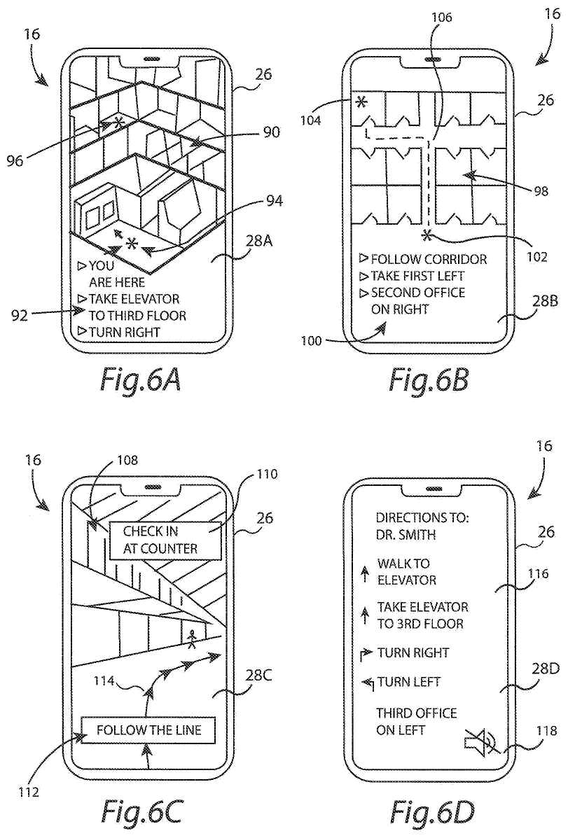

FIGS. 6A-6D illustrate several example wayfinding displays with a LiDAR equipped user mobile device 16. By “display” it is meant herein a visual display, such as on touchscreen 28, an auditory display, e.g. via speaker 44, or other user feedback such as a haptic display. FIG. 6A illustrates an example visual touchscreen display 28A including a cutaway 3D rendering 90 of a building along with written instructions 92 on how to navigate from a user position 94 to a desired destination 96 within the building. FIG. 6B illustrates an example visual touchscreen display 20B including a 2D map 98 and written instructions 100 on how to navigate from a user position 102 to a desired destination 104 along a path 106. FIG. 6C illustrates an augmented reality (AR) 108 display on a touchscreen 28C display which uses one or more of cameras 36 and the LiDAR module 40 to display the current environment with an overlay of instructions 110, 112, etc. and a path line 114 to a desired destination (the “check-in” counter in this example). FIG. 6D illustrates a written directions display 116 on a touchscreen display 28D which has the option for an auditory display of the directions by selecting a “sound” icon 118.

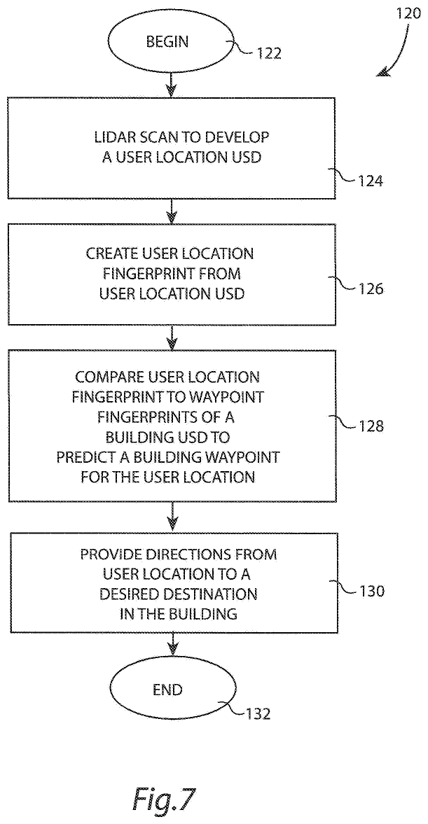

FIG. 7 is a flow diagram of an example process (a/k/a “method”) 120 implemented by a LiDAR equipped user mobile device 16 by, for example, an app “A” of FIG. 3. Process 120 begins at 122 and, in an operation 124, the user LiDAR-scans the local environment (e.g. room) to develop a location 3D model as a user location USD. Next, in an operation 126, a user location fingerprint is created from the location USD and, in an operation 128, the user location fingerprint is compared to waypoint fingerprints of a building USD in order to predict a building waypoint for the user location. It should be noted that the user location fingerprint may be related to several of the waypoint fingerprints (e.g. the building may have several rooms with similar layouts), in which case a ranked list of probabilities of the match may be provided as in the following example:

### Ranked List of Possible Waypoints

(1) 82% Waypoint 47
(2) 13% Waypoint 52
(3) 3% Waypoint 98

The process 120 can then choose the most probably waypoint or repeat operations 124 to 128 until a sufficiently high confidence of a waypoint location is achieved. Finally, in an operation 130, the user is provided with directions from the user location to a desired destination in the building. After arrival at the destination, the process 120 ends at 132.

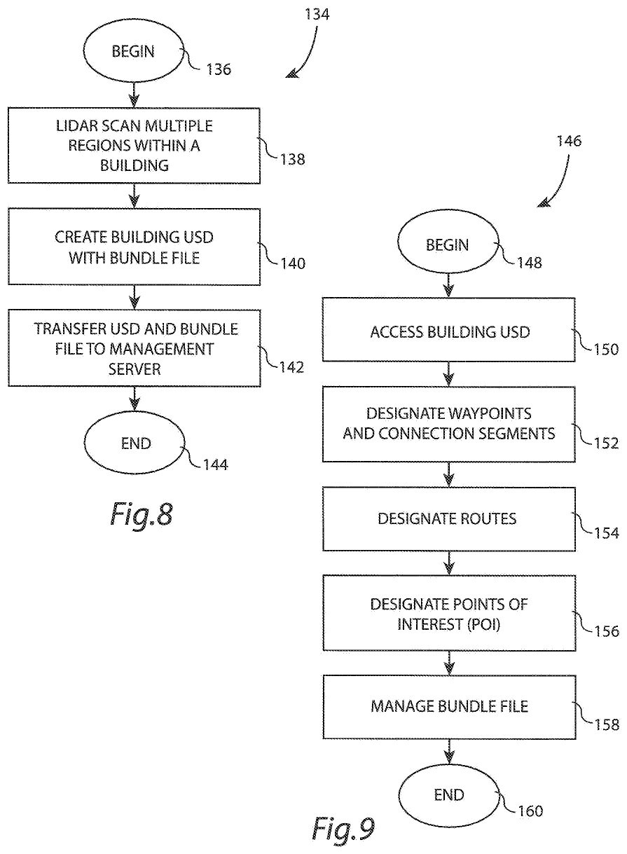

FIG. 8 is a flow diagram of an example process 134 implemented on a LiDAR equipped mapper mobile device 12 by, for example, an app “A” of FIG. 3. Process 134 begins at 136 and, in an operation 138, multiple regions (e.g. rooms, hallways, open spaces, etc.) within a building are LiDAR-scanned by the mobile device 12. Next, in an operation 140, the LiDAR-scans are used to create a building USD along with an optional building bundle file including metadata associated with the building). The building USD (and bundle file, if any) are then transferred to the management server 14 by operation 142. Process 134 then ends at 144.

FIG. 9 is a flow diagram of an example process 146 implemented on a manager station 18 of FIG. 1. Process 146 begins at 148 and, in an operation 150 a building USD is accessed from, for example, the management server 14. Next, waypoints and connecting segments are designated for the building in an operation 152. For example, a room can have a waypoint, and the hallway outside of the room can be another waypoint, with a connecting segment between the two. It should be noted that the designation of the waypoints and connecting segments can be manually determined by a manager or can be automatically generated. Next, in an operation 154 routes between waypoints can be automatically or manually designated. Alternatively, the routes can be determined later in, for example, a LiDAR equipped mapper mobile device 12. Optionally, in an operation 156, the manager can designate points-of-interest (POI) for the building. An operation 158 manages the building bundle file by either creating or updating the file with metadata including e.g. waypoints, segments, routes, POI, etc. Process 146 ends at 160.

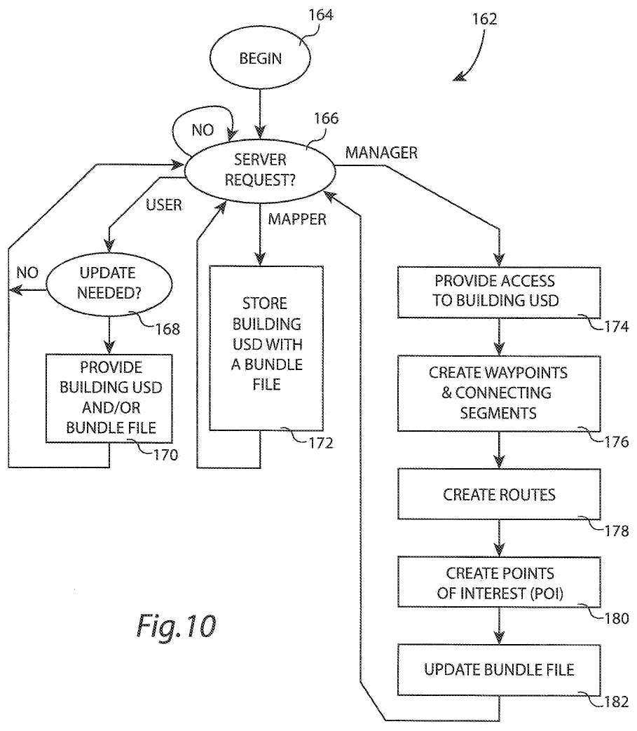

FIG. 10 is a flow diagram of an example process 162 implemented on a management server 14 of FIG. 1. Process 162 begins a 164 and, in an operation 166, it is determined if there has been a server request. If not, operation 166 idles. If there is a server request from a user, e.g. a user of a LIDAR equipped user mobile device 16, an operation 168 determines if the user needs a new or updated building USD and/or building bundle file. If not, control returns operation 166. If a new or updated building USD and/or building bundle file is needed, it is provided to the user in an operation 170, e.g. by a download operation over the internet 20. If there is a server request from a mapper, e.g. from a LIDAR equipped mapper mobile device 12, an operation 172 stores a building USD with a building bundle file in, for example, database 22 of FIG. 1. If operation 166 receives a server request from a manager, e.g. from a manager station 18, an operation 174 provides access to the manager for a designated building USD. This server request can be, for example, in response to the access building USD operation 150 of FIG. 9. In an operation 176, waypoints and connecting segments are created in response, for example, a designate waypoints and connecting segments operation 152 of FIG. 9. In operation 178, routes are created automatically, or in response to operation 154 of FIG. 9, or a combination of the two. In operation 180, points-of-interest (POI) are created in response to operation 156 of FIG. 9. Finally, an operation 182 updates (or creates) a building bundle file with metadata derived from operations 176-180 and any manage bundle file operation 158 of FIG. 9. Process control then returns to operation 166 to await further service requests.

The Universal Scene Description (USD) is a framework for interchange of 3D computer graphics data that was developed by Pixar Animation Studios (“Pixar”) of Emeryville, California, now a subsidiary of Walt Disney Studios of Burbank, California. The USD framework was first published as open source software in 2016.

In Apple, Inc.'s recent release of iOS 16, a new application program interface (API) for a technology known as “RoomPlan” can use iPhone built-in LiDAR with its cameras to create 3D floor plans. A description of RoomPlan along with sample code can be found at https://developer.apple.com/documentation/roomplan, incorporated herein by reference. RoomPlan can be invoked via an app to create a 3D model of an interior room. The RoomPlan framework uses an iPhone's sensors, trained ML models, and RealityKit's rendering capabilities to capture the physical surroundings of an interior room. For example, the framework inspects an iPhone's camera feed and LiDAR readings to identify walls, windows, openings, and doors. RoomPlan also recognizes room features, furniture, and appliances, such as a fireplace, bed, or refrigerator, and provides that information to the app.

To begin a capture, the app presents a view (RoomCaptureView) that the user uses to see their room in Augmented Reality (“AR”). The view displays virtual cues as they move around the room:
Real-time graphic overlays display on top of physical structures in the room to convey scanning progress.
If the framework requires a specific kind of device movement or perspective to complete the capture, the UI displays instructions that explain how to position the device.

When the app determines that the current scan is complete, the view displays a small-scale version of the scanned room for the user to approve. Alternatively, the app can display custom graphics during the scanning process by creating and using a scan session object (RoomCaptureSession) directly. The framework outputs a scan as parametric data, which makes it easy for the app to modify the scanned room's individual components. RoomPlan also provides the results in a Universal Scene Description (USD) format.

In computer science, a fingerprinting algorithm is a procedure that maps an arbitrarily large data item, software or other digital file (“digital object”) to a much shorter bit string known as its “fingerprint.” The fingerprint uniquely identifies the original digital object for all practical purposes. Typically, fingerprint algorithms use high-performance hash functions to uniquely identify digital objects.

In the current example, a fingerprint developed from a user location USD of a room will be somewhat different than the fingerprint of that room that was developed from a building USD. The building bundle can assist in the comparison process by providing metadata for the room including total room volume, fractal dimension of color pattern on the floor, walls and ceiling, as well as the fractal dimensions of large scale objects in the scan. See, for example, Fractal Dimension (FD): image as a single real number, MAST research project, University of Plymouth, accessed on Nov. 17, 2022 at the URL:
https://www.plymouth.ac.uk/research/materials-and-structures-research-group/fractal-dimension-fd-image-as-a-single-real-number
   and incorporated herein by reference.

In this example, the set of numbers derived from the aforementioned process can then be considered to be the coordinates of a point in feature space. This “feature vector” represents the associated scan, and this association is recorded in a database. In an example embodiment, recursive subdivision of feature space is used to organize the feature vectors so that the subsequent search times using the index are reduced.

When a user is navigating, a LiDAR-scan is taken, and a feature vector is developed for the scan. This feature vector is used to locate the nearest stored scan in the index. The Euclidean distance between the search feature vector and a possible matching feature vector is used as a score for the possible match. These possible matches can be ranked by probability (“score”), as described previously.

Although various embodiments have been described using specific terms and devices, such description is for illustrative purposes only. The words used are words of description rather than of limitation. It is to be understood that changes and variations may be made by those of ordinary skill in the art without departing from the spirit or the scope of various inventions supported by the written disclosure and the drawings. In addition, it should be understood that aspects of various other embodiments may be interchanged either in whole or in part. It is therefore intended that the claims be interpreted in accordance with the true spirit and scope of the invention without limitation or estoppel.

What is claimed is:

1. A LIDAR enabled wayfinding system comprising:
a LiDAR equipped mapper mobile device adapted to LiDAR-scan within a building to create a building Universal Scene Description (USD);
a management server receptive to the building USD and operative to maintain a building bundle file including a plurality of waypoints associated with a corresponding plurality of waypoint fingerprints; and
a LiDAR equipped user mobile device adapted to LiDAR-scan a user location within the building and to develop a user location USD and user location fingerprint that is compared to the plurality of waypoint fingerprints to identify a waypoint proximate to the user location.

2. A LIDAR enabled wayfinding system as recited in claim 1 further comprising:
a manager station coupled to the management server to manage the building bundle file.

3. A LIDAR enabled wayfinding system as recited in claim 2 wherein the building bundle file further includes a plurality segments connecting the plurality of waypoints.

4. A LIDAR enabled wayfinding system as recited in claim 3 wherein the building bundle file further includes a plurality of routes including at least some of the plurality of waypoints and the plurality of segments.

5. A LIDAR enabled wayfinding system as recited in claim 4 wherein the building bundle file further includes one or more points of interest (POI).

6. A LIDAR enabled wayfinding system as recited in claim 2 wherein the building includes a plurality of rooms, and wherein the LiDAR equipped mapper mobile device is adapted to sequentially LiDAR-scan the plurality of rooms to at least partially create the building USD.

7. A LIDAR enabled wayfinding system as recited in claim 6 wherein the LiDAR equipped mapper mobile device includes at least one location sensor selected from the group consisting essentially of a compass, an altimeter, a BLE Bluetooth receiver, a WiFi receiver, and a GPS device.

8. A LIDAR enabled wayfinding system as recited in claim 2 wherein both the plurality of waypoint fingerprints and the user location fingerprint are created by a hashing process.

9. A LIDAR enabled wayfinding system as recited in claim 8 wherein the LiDAR equipped user mobile device performs a ranked correlation between the location fingerprint and the plurality of waypoint region fingerprints to develop a ranked list of waypoints that are proximate to the user.

10. A method for LiDAR enabled wayfinding comprising:
LiDAR-scanning within a building by a user to develop a user location Universal Scene Description (USD);
creating a user location fingerprint from the user location USD;
comparing the user location fingerprint with a plurality of waypoint fingerprints associated with a plurality of waypoints of the building to predict a waypoint location of the user within the building; and
providing directions for the user to navigate from the user location to a desired destination within the building.

11. A method for LiDAR enabled wayfinding as recited in claim 10 wherein LiDAR-scanning within a building comprises LiDAR-scanning an environment of the user in a plurality of directions and orientations.

12. A method for LiDAR enabled wayfinding as recited in claim 11 further comprising:
LiDAR-scanning a plurality of regions within a building with a mapper mobile device LIDAR device; and
creating a building USD from the LiDAR-scanning within the building; and
developing a building bundle file including a plurality of waypoints within the building and a plurality of segments connecting the plurality of waypoints.

13. A method for LiDAR enabled wayfinding as recited in claim 12 wherein the building USD includes at least one location parameter selected from the group consisting essentially of a compass direction, an altitude, a beacon identifier and a GPS location.

14. A method for LiDAR enabled wayfinding as recited in claim 11 further comprising performing a ranked correlation between the location fingerprint and the plurality of waypoint fingerprints to provide a ranked list of waypoints proximate to the user.

15. Non-transitory computer readable media including code segments executable on a user LiDAR device comprising:
code segments for LiDAR-scanning a region within a building with a user LiDAR device to develop a user location Universal Scene Description (USD);
code segments for creating a location fingerprint from the location USD;
code segments for comparing the location fingerprint with a plurality of waypoint fingerprints associated with a plurality of waypoints of the building to predict a waypoint location of the user within the building; and
code segments for providing directions to navigate from the user location to a desired destination within the building.

16. Non-transitory computer readable media including code segments executable on a user LiDAR device as recited in claim 15 wherein LiDAR-scanning a region within a building comprises LiDAR-scanning the region in a plurality of directions and orientations.

17. Non-transitory computer readable media including code segments that are executable on a user LiDAR device as recited in claim 16 further comprising:
code segments for LiDAR-scanning a plurality of regions within a building with a mapper mobile device; and
code segments for creating a building USD from the LiDAR-scanning within the building; and
code segments for developing a building bundle file including a plurality of waypoints within the building and a plurality of segments connecting the plurality of waypoints.

18. Non-transitory computer readable media including code segments that are executable on a user LiDAR device as recited in claim 17 wherein the building USD includes at least one location parameter selected from the group consisting essentially of a compass direction, an altitude, a beacon and a GPS location.

19. Non-transitory computer readable media including code segments that are executable on a user LiDAR device as recited in claim 16 further comprising code segments performing a ranked correlation between the location fingerprint and the plurality of waypoint fingerprints to provide ranked a ranked list of proximate waypoints to the user.
